(19) United States
(12) Patent Application Publication
(10) Pub. No.: US 2026/0254314 A1
(43) Pub. Date: Aug. 27, 2026

(54) POWER GENERATING DEVICE

(71) Applicant: TET ENERGY GmbH, Egelsbach (DE)

(72) Inventor: Karl SALZMANN, Ginsheim-Gustavsburg (DE)

(21) Appl. No.: 19/163,263

(22) PCT Filed: Oct. 28, 2024
(86) PCT No.: PCT/EP2024/000057

§ 371 Date: Sep. 8, 2025

(30) Foreign Application Priority Data
Nov. 7, 2023 (DE) 10 2023 130 834.3

(51) Int. Cl. H02K 7/075; F16C 3/06; F16C 3/22

(52) U.S. Cl. CPC H02K 7/075; F16C 3/06; F16C 3/22

(57) ABSTRACT

A power generating device includes at least one cylindrical coil winding that encloses an interior space in which at least one annular permanent magnet is arranged. The coil winding and the permanent magnet are arranged such that they can be driven so as to be coaxially movable relative to one another. A crankshaft, which can be driven rotatably by a drive, has a crank that extends radially outward from the crankshaft, wherein the permanent magnet can be driven by the crank so as to be coaxially movable relative to the stationary coil winding.

The invention relates to a power generating device comprising at least one cylindrical coil winding that encloses an interior space in which at least one annular permanent magnet is arranged, wherein the coil winding and the permanent magnet are arranged such that they can be driven so as to be coaxially movable relative to one another.

It is therefore an object of the invention to provide a power generating device of the type mentioned at the outset which has a simple and cost-effective construction of small structural volume and a high efficiency.

This object is achieved according to the invention in that a crankshaft, which can be driven rotatably by a drive, has a crank that extends radially outward from the crankshaft, wherein the permanent magnet can be driven by the crank so as to be coaxially movable relative to the stationary coil winding.

The crankshaft and crank result in a construction requiring only a small structural volume, which is low in wear and thus has a long life and possesses a high degree of efficiency. The construction can be produced very cost-effectively.

The power generating device according to the invention generates clean, 100% CO2 pollutant-free power.

Furthermore, the object is achieved according to the invention in that the crankshaft which can be driven rotatably by a drive has at least a first crank and a second crank, wherein the first crank and the second crank extend radially outward from the crank shaft offset by an angle with respect to one another, and wherein the coil winding can be driven coaxially movably by the first crank and the permanent magnet can be driven coaxially movably by the second crank.

### In Addition to the Advantages of Claim 1, the Movement of

the coil winding permanent magnet in opposite directions with a double stroke of action results in a doubled relative speed of the coil winding and permanent magnet and thus in a double inductance and double the number of volts.

The movement in the opposite direction achieves a double effective total stroke, wherein the individual permanent magnets touch the winding synchronously in sequence an equal number of times, whereby enormous measures of alternating voltage pulses are achieved.

At the same time, a load distribution of the acceleration energy over the entire mechanism is obtained, since the nominal rotational speed of the drive can be kept very low in this case.

A particularly high degree of efficiency is achieved if the first crank and the second crank extend diametrically with respect to one another away from the crankshaft.

For coaxial movement, the coil winding or the coil windings and/or the permanent magnet or the permanent magnets can be guided coaxially in guides.

If the coil winding or the coil windings is/are arranged on a coil carrier, these are held in a positionally stable manner in a simple way.

Simple cooling of the coil winding or the coil windings is achieved in that the coil winding or the coil windings are arranged in the coil carrier so as to be partially exposed radially outward. The movement of coil winding or coil windings and permanent magnets in opposite directions results in permanent air intake and air displacement in the interior space of the coil winding or coil windings and thus in cooling of the coil winding or coil windings and permanent magnets. Power losses due to heating are thereby substantially reduced. The number of volts produced can thereby be kept largely constant.

A construction-space-saving and cost-effective embodiment consists in the coil carrier carrying two coil windings or two rows of coil windings parallel at a distance from one another and being drivable coaxially movably by a push rod.

For the stably guided movement, the coil carrier can be guided coaxially on a stationary rolling table.

The first crank can be connected to the coil carrier via a first push rod.

If the first push rod is formed coaxially in at least two parts and if two parts of the first push rod are connected to one another via a compression spring, the actual effective stroke is extended by the compressing and expanding of the compression spring. Furthermore, due to its work, the compression spring improves the speed during the insertion and removal of the permanent magnet into the coil winding, whereby the generated volt number is increased.

For the movement drive of the permanent magnet or the permanent magnets, the crank or second crank can be connected to the permanent magnet or the permanent magnets via a push rod or second push rod, wherein the permanent magnet or the permanent magnets can be arranged on the push rod or second push rod.

If the push rod or second push rod is formed coaxially in at least two parts and if two parts of the push rod or second push rod are connected to one another via a compression spring, the actual effective stroke is extended by the compression and expansion of the compression spring.

For coaxial guidance, the push rod or second push rod can be guided coaxially at its first and second end regions in first and second guide openings of stationary first and second guide pieces, wherein the region of the push rod or second push rod having the compression spring can be guided in the first guide opening of the first guide piece. By means of the guidance in the guide pieces, it is possible for the push rod or second push rod of permanent magnet or of the permanent magnets to be guided in a floating manner with the smallest possible air gap of the permanent magnets to the coil winding. The guides can have bearings, such as axial Teflon needle bearings, which have only very low friction.

For the simple connection of the crank and the push rod while preventing the push rod from jamming, the free end of the first crank can be articulated on the first push rod about a pivot axis parallel to the crankshaft and/or the free end of the crank or second crank can be articulated on the second push rod about a pivot axis parallel to the crankshaft or second pivot axis.

In order that the permanent magnets do not move away from one another, the number of permanent magnets can be braced axially to form a permanent magnet pack.

This is possible in a simple manner by virtue of the fact that the number of permanent magnets is braced axially to form a permanent magnet pack by means of a screw connection.

The coil windings are preferably arranged at predetermined axial distances from one another and the permanent magnets are preferably arranged at predetermined axial distances from one another.

In order that there is always an overlap of coil windings and permanent magnets in an improving manner of power, the axial distances of the coil windings can correspond to the distances of the permanent magnets and the width of the coil windings can correspond to the width of the permanent magnets, wherein the width of the coil windings and permanent magnets is greater than the distances between coil windings and permanent magnets.

To ensure the distances between the coil windings and/or the permanent magnets, the distances can be predetermined in a simple manner by means of non-magnetic spacer rings between the coil windings and/or permanent magnets.

An exemplary embodiment of the invention is illustrated in the drawing and is described in more detail below. In the drawing

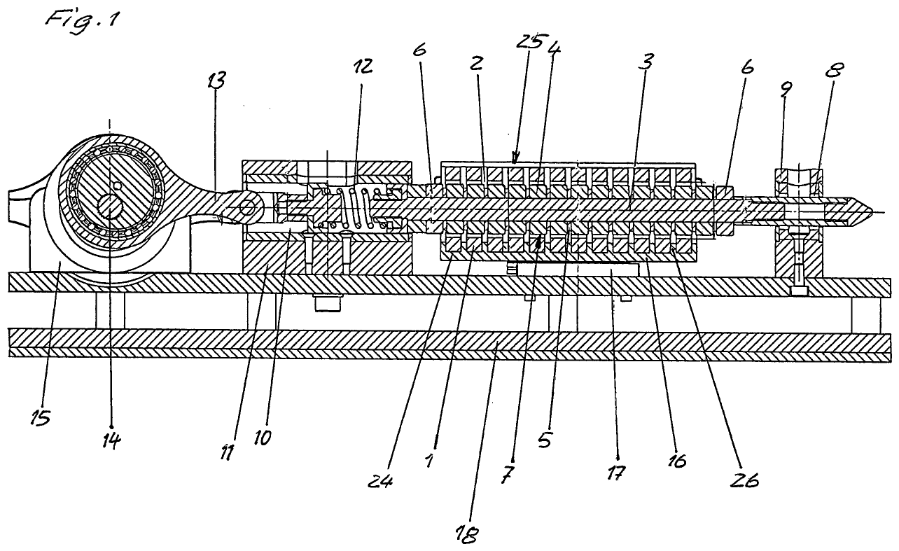

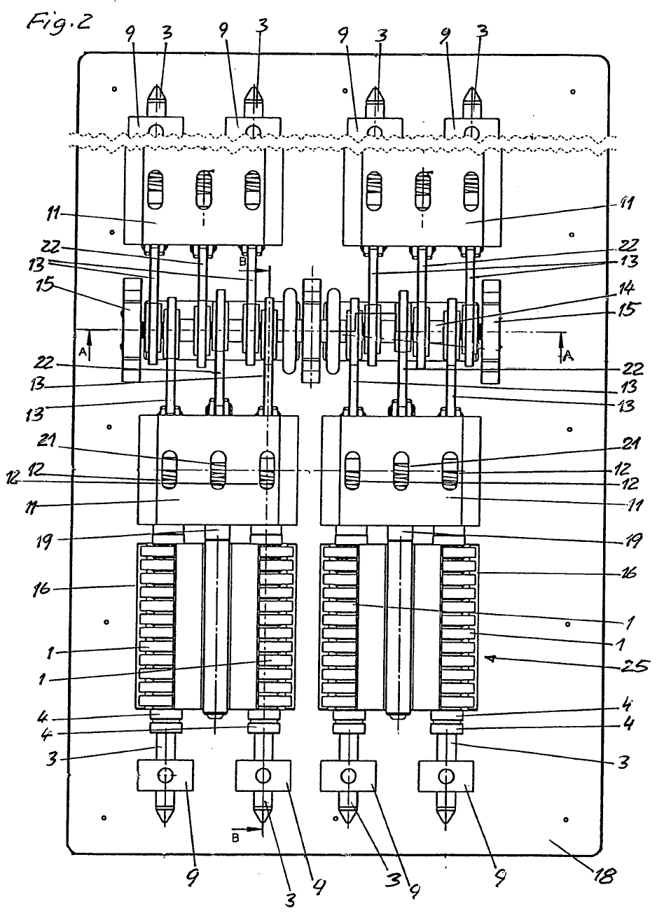

FIG. 1 shows a longitudinal section along the line B-B in FIG. 2 of a unit consisting of a coil winding pack and a permanent magnet pack of a power generating device

FIG. 2 shows a plan view of a plurality of units consisting of permanent magnet pack units and coil winding pack units of a power generating device according to FIG. 1

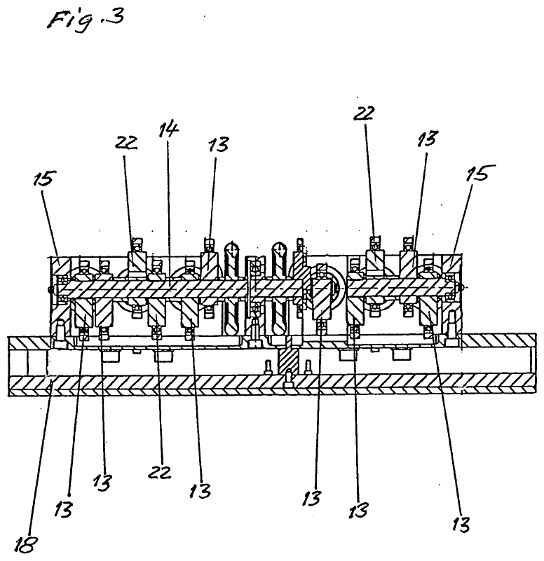

FIG. 3 shows a cross-sectional view of the power generating device taken along the line A-A in FIG. 2

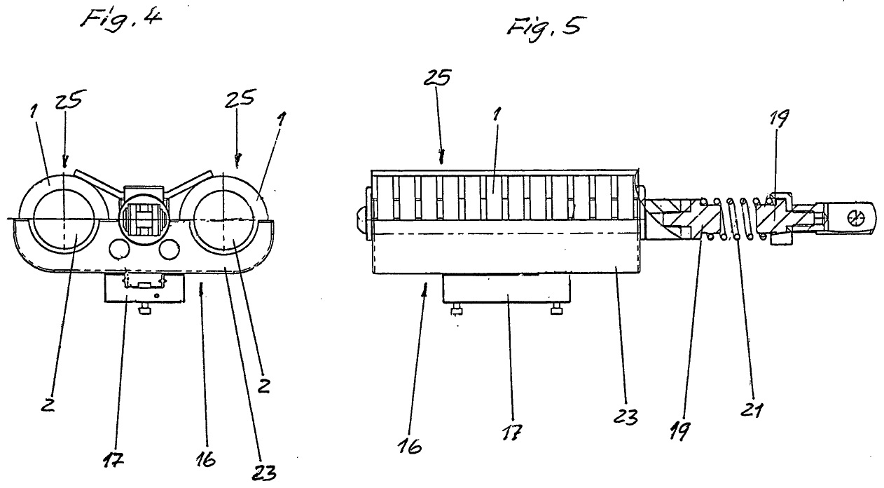

FIG. 4 shows an end view of a coil carrier of the power generating device according to FIG. 1

FIG. 5 shows a side view of the coil carrier according to FIG. 4

The power generating device shown in the figures has multiple coil windings 1, each of which encloses a cylindrical interior space 2, in which multiple ring-shaped permanent magnets 4 are arranged next to one another on a second push rod 3 coaxially to the coil winding 1. By means of non-magnetic second spacer rings 5 arranged between the individual permanent magnets 4, the permanent magnets 4 are held at predetermined axial distances from one another.

The coil windings 1 are wound alternately to the right and left. The permanent magnets 4 are each arranged with the same polarity with respect to one another. At the end regions of the permanent magnet pack 7, the second push rod 3 has threads, onto which nuts 6 are screwed, which axially clamp the permanent magnets 4 to form the permanent magnet pack 7.

In FIG. 1, outside the permanent magnet pack 7, the right end of the second push rod 3 projects through a second guide opening 8 of a stationary second guide piece 9 and is guided therein in an axially displaceable manner.

Outside the permanent magnet pack 7, the left end of the second push rod 3 is embodied in two parts and is guided displaceably through a third guide opening 10 of a stationary first guide piece 11.

Between the mutually facing ends of the two parts of the second push rod 3 a second helical compression spring 12 is arranged, which connects the two parts of the second push rod 3 to one another.

The part of the second push rod 3 which does not carry the permanent magnets is articulated at its end remote from the part carrying the permanent magnets to a second crank 13. The second crank 13 is mounted eccentrically radially on a crankshaft 14, which extends transversely the longitudinal extension of the second push rod 3 and can be driven rotatably by a drive, not shown.

The crankshaft 14 is rotatably mounted on stationary bearing blocks 15.

As can be seen in particular in FIG. 2, two of the arrangements described above of the second push rod 3 and the permanent magnet pack 7 are arranged parallel to one another.

Between these two arrangements of second push rod 3 and permanent magnet pack 7, an arrangement with coil winding 1 is arranged parallel to these, as is shown in more detail in FIGS. 4 and 5.

In this case, two coil winding packs 25 of coil windings 1 are arranged in a coil carrier 16 parallel to one another, which each extend coaxial to the permanent magnet packs 7. The permanent magnet packs 7 are located in each of the cylindrical inner spaces 2 of the coil winding packs 25 with only a small radial air gap to the coil windings 1 of the coil winding packs 25.

The coil carrier 16 is displaceably guided by means of a rolling table 17 on a base plate 18 of the power generating device transversely to the crankshaft 14.

At its right-hand end in FIG. 5, a first push rod 19 is arranged parallel to the coil winding pairs 25, which is embodied in two parts.

The first push rod 19 is displaceably guided through a first guide opening of the stationary first guide piece 11.

Between the mutually facing ends of the two parts of the first push rod 19 a first helical compression spring 21 is arranged, which connects the two parts of the first push rod 19 to one another.

The part of the first push rod 19 facing away from the coil carrier 16 is articulated at its end facing away from the coil carrier 16 on a first curved portion 22 about a pivot axis parallel to the crankshaft 14. The first crank 22 is eccentrically mounted radially on the crankshaft 14.

The coil carrier 16 made of a non-magnetic material is open at its upper half remote from the rolling table 17. In the lower half 23, receiving grooves 24 are formed corresponding to the coil windings 1 for receiving the coil windings 1, into which the coil windings 1 are inserted. Webs 26 formed integrally with the coil carrier 16 protrude between the individual coil windings 1, said webs holding the coil windings 1 as spacer rings at a distance from one another which corresponds to the width of the second spacer rings 5 of the permanent magnet pole 7.

The number of coil windings 1 of the coil winding packs 25 is numbered, while the number of permanent magnets 4 of the permanent magnet packs 7 is odd numbered.

The first crank 22 and the second crank 13 extend away from the crankshaft 14 in opposite directions to each other, so that the coil winding packs 25 and the permanent magnet packs 7 always perform an opposing movement with respect to each other.

As shown in FIG. 2, a single crankshaft 14 can drive a plurality of units consisting of permanent magnet pack units and coil winding pack units, arranged next to one another as well as one behind the other.

### LIST OF REFERENCE SIGNS

1 coil windings
2 interior space
3 second push rod
4 permanent magnets
5 second spacer rings
6 nuts
7 permanent magnet pack
8 second guide opening
9 second guide piece
10 third guide opening
11 first guide piece
12 second helical compression spring
13 second crank
14 crankshaft
15 bearing blocks
16 coil carriers
17 rolling table
18 base plate
19 first push rod
21 first helical compression spring
22 first crank
23 lower half
24 receiving grooves
25 coil winding pack
26 webs

1. A power generating device comprising:
at least one cylindrical coil winding (1) which encloses an interior space (2) in which at least one annular permanent magnet (4) is arranged, wherein the at least one coil winding (1) and the at least one permanent magnet (4) are arranged such that they can be driven so as to be coaxially movable relative to one another, and
a crankshaft (14), which can be driven rotatably by a drive, having a crank (13) that extends radially outward from the crankshaft (14), wherein the permanent magnet (4) can be driven by the crank (13) so as to be coaxially movable relative to the stationary coil winding (1).

2. A power generating device comprising:
at least one cylindrical coil winding (1) which encloses an interior space (2) in which at least one annular permanent magnet (4) is arranged, wherein the at least one coil winding and the at least one permanent magnet (4) are arranged such that they can be driven so as to be coaxially movable relative to one another, and a crankshaft (14), which can be driven rotatably by a drive, having at least a first crank (22) and a second crank (13), wherein the first crank (22) and the second crank (13) extend radially away from the crankshaft (14) offset from one another by an angle, and wherein the at least one coil winding (1) can be driven coaxially movably by the first crank (22) and the at least one permanent magnet (4) can be driven coaxially movably by the second crank (13).

3. The power generating device according to claim 2, wherein the first crank (22) and the second crank (13) extend diametrically with respect to one another away from the crankshaft (14).

4. The power generating device according to claim 2, wherein the at least one coil winding (1) and the at least one permanent magnet are coaxially guided in guides.

5. The power generating device according to claim 2, wherein the at least one coil winding (1) is arranged on a coil carrier (16).

6. The power generating device according to claim 5, wherein the at least one coil winding (1) is arranged in the coil carrier (16) so as to be partially exposed radially outward.

7. The power generating device according to claim 5, wherein the coil carrier (16) carries two sets of the at least one coil winding parallel at a distance from one another and can be driven coaxially movably by a push rod (19).

8. The power generating device according to claim 5, wherein the coil carrier (16) is coaxially guided on a stationary rolling table (14).

9. The power generating device according to claim 2, wherein the at least one coil winding (1) is arranged on a coil carrier (16) and the first crank (22) is connected via a first push rod (19) to the coil carrier (16).

10. The power generating device according to claim 9, wherein the first push rod (19) is formed coaxially in two parts and in each case two parts of the first push rod (19) are connected to one another by a compression spring (21).

11. The power generating device according to claim 2, wherein the second crank (13) is connected to the at least one permanent magnet by a second push rod (3).

12. The power generating device according to claim 11, wherein the at least one permanent magnet is arranged on the second push rod (3).

13. The power generating device according to claim 12, wherein the second push rod (3) is formed coaxially in two parts and the two parts of the second push rod (3) are connected to one another via a compression spring (12).

14. The power generating device according to claim 12, wherein the second push rod (3) is coaxially guided at its first and second end regions in first and second guide openings (8) of stationary first and second guide pieces (11, 9).

15. The power generating device according to claim 14, wherein a region of the second push rod (3) comprising the compression spring (12) is guided in the first guide opening of the first guide piece (11).

16. The power generating device according to claim 2, characterized in that a free end of the first crank (22) is articulated on a first push rod (19) about a pivot axis parallel to the crankshaft (14) for driving the at least one coil winding (1) and a free end of the crank second crank (13) is articulated on a second push rod (3) so as to be pivotable about a second pivot axis parallel to the crankshaft (14) for driving the at least one permanent magnet.

17. The power generating device according to claim 1, wherein the at least one coil winding (1) is arranged on a coil carrier (16).

18. The power generating device according to claim 17, wherein the at least one coil winding (1) is arranged in the coil carrier (16) so as to be partially exposed radially outward.

19. The power generating device according to claim 17, wherein the coil carrier (16) carries two sets of the at least one coil winding parallel at a distance from one another and can be driven coaxially movably by a push rod (19).

20. The power generating device according to claim 17, wherein the coil carrier (16) is coaxially guided on a stationary rolling table (14).

21. The power generating device according to claim 1, wherein the crank (13) is connected to the at least one permanent magnet by a push rod (3).

22. The power generating device according to claim 21, wherein the at least one permanent magnet is arranged on the push rod (3).

23. The power generating device according to claim 22, wherein the push rod (3) is formed coaxially in two parts and the two parts of the push rod (3) are connected to one another via a compression spring (12).

24. The power generating device according to claim 22, wherein the push rod (3) is coaxially guided at its first and second end regions in first and second guide openings (8) of stationary first and second guide pieces (11, 9).

25. The power generating device according to claim 24, wherein a region of the push rod (3) comprising the compression spring (12) is guided in the first guide opening of the first guide piece (11).

26. The power generating device according to claim 1, wherein a free end of the crank (13) is articulated on a push rod (3) so as to be pivotable about a pivot axis parallel to the crankshaft (14) for driving the at least one permanent magnet.
